(19) United States
(12) Patent Application Publication
(10) Pub. No.: US 2006/0168325 A1
(43) Pub. Date: Jul. 27, 2006

(54) Control of a copy of an original document cached on a remote client computer

(76) Inventors: Gregory Joseph Wood, Bromham (GB); Bryan David Avery, Bromham (GB)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/212,973

(22) Filed: Aug. 25, 2005

Related U.S. Application Data
(63) Continuation-in-part of application No. PCT/GB04/00735, filed on Feb. 24, 2004.

(30) Foreign Application Priority Data
Feb. 25, 2003 (GB) 0304297.5

(51) Int. Cl. G06F 15/173

(52) U.S. Cl. 709/238

(57) ABSTRACT

A data processing system comprises a document server (5), a messaging server (4) and a client (1). The client communicates over a network (7, 10) with the document server to request a copy of a document stored on the document server. The document server is configured so that in response to such request a client copy of the document is downloaded to the client from the document server. The client (1) is configured so that a client application (13) running on the client communicates with the messaging server (4) and registers information with a messaging server application (14), the information identifying the client and the document that has been downloaded. The document server (5) is further configured so that when the document that has been downloaded is updated on the document server, a document server application (15) communicates with the messaging server (4) and provides instructions to be carried out by the client application. The messaging server is configured so that by reference to the registered information, the instructions are provided to the client application by the messaging server application. The client application stores the instructions and, in response to a request by a user to access the client copy of the document, the stored instructions are carried out. Typically the instructions would be to retrieve the updated version of the document.

This invention relates to document control, in the context of systems in which client data processing apparatus stores a local copy of an original document located on remote data processing apparatus.

It is well known for a client computer to download a document over a network from a remote server so that the document can be analysed locally whilst the client is disconnected from the server. For example, a financial adviser may access financial data over the Internet, and store the results locally for analysis. Increasing numbers of independent financial advisers (IFA's) are developing local archives of documents obtained from the servers of companies providing life insurance, pensions, investments and so forth. If the archived information becomes out of date, serious problems can arise. Non-compliant information may be relied upon and get into circulation, and the resultant difficulties are likely to lead to lost business and disciplinary action by regulatory authorities in the financial sector.

In U.S. Pat. No. 6,061,686 there is proposed a system that is intended to alleviate some problems associated with local storage of documents that may be updated on a remote original document server. In this prior art system, in addition to the original document server, there is provided an update server, both being connected to a network such as the Internet. There is also provided client software and update server software.

When the client computer downloads a page for local storage, a local database stores the location (URL) of the original document and the time/date of updating. The client software then connects to the update server, and registers the client computer, the URL of the page that has been downloaded, and the update time/date. This information is stored in a database on the update server. At this point the client computer may be disconnected from the network. The update server then connects to the original document server and downloads and stores its own copy of the document, together with its date of last update. At intervals, the update server connects to the original document server, ascertains if the date of last update is later than that of the update copy that is stored on the update server, and if necessary downloads the latest version of the document, storing its date of last update.

When the client computer connects to the network again, the client software automatically accesses the update server. In respect of any documents which are registered on the update server for that client computer, the update server compares the date of last update stored on the update server with that stored on the client computer. If the date stored on the update server is later, then the update server copy of the document is downloaded to the client computer to replace the out-of-date copy.

One problem with this system is that the document on the client computer will only be as up-to-date as the version stored on the update server. The update server only connects to the original document server at intervals and may therefore be out of date itself. There is therefore a tangible risk of out of date information being relied upon if the update server is used.

Another problem with the prior art system is that once a client computer is connected to the network the update server will carry out its operations. Thus, there will be delays whilst updated documents are downloaded to the client computer even if the user does not want to access any of them at that time.

It is known for messages to be sent to client computers, for example by e-mail, indicating that an updated version of a document stored on the client computer has been updated. Such a message may include, for example, a hyperlink to a web page where the updated document can be downloaded if the user wishes. Such systems are obtrusive because they will alert a user to an update even when the user has no interest in the document.

There are other circumstances in which it is desirable to control access to locally stored documents. Apart from insisting that an updated version be downloaded, it would be desirable to be able to invoke other rules, for example controlling the period for which a document is valid or may be accessed, whether a subscription is required and so forth.

Viewed from one aspect, the present invention provides a method in which client data processing apparatus communicates over a network with a document server on which is stored an original copy of a document, a client copy of the document is received by the client data processing apparatus for off line use, and a server on the network registers data indicating that the client copy of the document is on the client data processing apparatus; wherein a rule is generated relating to the document; by reference to the registered data in respect of the client data processing apparatus the rule is communicated to a client application on the client data processing apparatus; in accordance with the rule the client application stores instructions to be carried out when a user next seeks to access the client copy of the document; a request is made by the user to access the client copy of the document; and in response to such a request being made, the client application carries out the stored instructions.

Associated aspects of the invention include:
a) A system of one or more servers and client data processing apparatus, the system being configured to operate in accordance with the method described above.
b) Data processing apparatus configured as the client data processing apparatus in such a system.
c) Computer software which when running on data processing apparatus will configure the data processing apparatus as the client data processing apparatus in the system.
d) A method of operating the client data processing apparatus in accordance with the method.
e) A system of one or more servers configured to operate in accordance with the method described above.
f) Data processing apparatus configured as a server in such a system. g) Computer software which when running on data processing apparatus will configure the data processing apparatus as a server in the system.
h) A method of operating a server in accordance with the method.

Typically, the rule would represent the fact that there has been an update to the original document and that the updated version must be downloaded to replace the version currently on the client data processing apparatus. By means of such a system, the necessary steps to be taken in respect of the client copy of the document, following an update to the original document, are carried out only when a user wishes to access the document. Time is not wasted downloading updated documents at times when the user is not interested in them.

The client application does not simply display messages sent to the client data processing apparatus, for example by e-mail, indicating to a user that there is an updated version. The client application stores instructions which will be carried out when a user next seeks to open a client copy of a document which has been updated on the original server.

At a basic level, the instructions to be carried out could consist of simply alerting the user to the fact that the client copy of the document is out of date. Preferably in such a simple arrangement there would be a link for the user to download the updated version. There might also be instructions blocking access to, or even deleting, the current client copy of the document. Preferably, however, the client application arranges for the client copy of the document to be updated when the user tries to access it. This may be achieved by automatically downloading the updated document, automatically downloading amendments to the client copy of the document, or by carrying out amendments to the client copy of the document in accordance with instructions contained in the original message sent to the client application.

There could be an alert to the user, even when a document is to be updated automatically. The user could opt to view the original version, and one way of achieving that would be for the instructions sent to the client application to include directions for the original version to be archived so that it will still be accessible for historical reasons. Alternatively, an archiving facility could be part of the client application, preferably selectable and/or configurable by a user. The user could opt to cancel the update operation completely. In any event, for so long as the updated version has not been downloaded, action will be taken in accordance with the instructions whenever a request is made to open the document.

Messages transmitted to the client data processing apparatus could be transmitted directly from the document server, but are preferably transmitted from a separate messaging server to which messages for distribution are provided by the document server or for example by a document management server. In any event there is a server, preferably a messaging server, on the network which registers data indicating that the client copy of the document is on the client data processing apparatus. The server preferably maintains a database for client machines, using unique id's, with the documents and versions that have been downloaded to the machines. Preferably this is achieved by the client application connecting to the appropriate server and transmitting a unique id for the particular machine on which the client application is running, together with data identifying the document and its version (for example a time/date stamp) that has been downloaded onto the machine. If the hardware is multi-user, as is the case with for example a terminal server, then the unique id may need to identify the user as well as the machine.

In one arrangement the client application maintains a database of downloaded documents and their versions, and data identifying any current instructions that are to be carried out when a user seeks to access particular documents. The contents of the database may be transmitted to the messaging server at intervals or in response to a request by the messaging server or a client user, so that a consistency check can be carried out as to what documents are on the client machine and what documents are registered with the messaging server.

The client database may be used in the generation of an environment by the client application in which documents which are on the client machine are listed so that they can be accessed, deleted and so forth. Actions taken such as deleting a document preferably result in a message being sent to the messaging server to indicate that a local copy of the document is no longer on the client machine. The local documents may be tagged so that any attempts to open them or delete them is monitored by the client application, regardless of whether such actions take place within an environment established by the client application or through standard file management features in the operating system of the machine or an independent application such as a word processor.

In one preferred arrangement, downloading new documents does not have to be done from within an environment established by the client application and a conventional web browser or other generally available technology can be used.

Documents which are downloaded by a user will automatically be registered if they are part of the system, and other documents will be treated in a conventional fashion. When any document is being downloaded, the client application could look for data in or accompanying the documents which indicates that a particular document is within the system, and then take appropriate action. Alternatively, code within or accompanying a document could run automatically before, during or after downloading of the document itself, or on the downloaded document first being opened on the client machine, which will initiate action being taken to register the document with the client application.

Such code may also check to determine whether the client application is installed on the client machine, and if not take action to have the application downloaded. The user may be given the option of accepting or refusing the software download to install the client application. Once the software has been downloaded and installed, and the document downloaded, the client application will register the identity of the client machine and the document with the messaging server.

Alternatively, a user may decide to install the client application before seeking to download a document, for example by accessing a download site on the Internet or installing the software from a CD or diskette.

In implementing the invention, rules, messages and instructions are preferably in the form of XML objects. Documents, rules, message and instructions may be transferred fully secure using for example the standard SSL context, or unsecured using standard methods.

In one preferred arrangement, the files of original documents are modified so that they can only be opened by invoking the client application. Thus starting with a file in a format such as Microsoft Word™ or Adobe Acrobat™, at the server end the file is modified by for example adding a header containing information such as the publication date, review date and expiry date of the document. The modified file may then be incompatible with the original application such as Word or Acrobat, and will have an identifier indicating that it is to be opened by the client application. This can be achieved, for example, by providing the file name with an extension that is registered as a file type for the client application. Thus, if the original document file has the name document.doc, the modified file could be given the name document.doc.xxx, where “xxx” is a file type extension registered for the client application. Such a file may be such that it can be opened directly from within the client application, but not from within other applications. If a user tries to open the file from within an environment such as a file management program or from a desktop (for example, in a Microsoft Windows™ environment by double clicking on the file name or icon,) the client application will be opened. This can, for example, generate a read only version of the original document, which is then opened with the original program for that document. Any rules that are registered in respect of the document will be carried out.

The association between the file and an application could be just a matter of file type registration so that the file can still be opened by an application other than that with which the file type is associated. However, it may also or alternatively be a matter of file compatibility so that the file cannot be opened with an incompatible application.

The rules relating to a document could be contained within the file itself, in the additional data which is added to the document as such. In such an arrangement, when a rule or rule change is notified to the client application, it will modify the file so as to incorporate the change. Thus, the file could be modified to include an XML rule which requires an updated document to be downloaded. When the file is subsequently accessed, the client application will read the rule and apply it. If the client application cannot locate the document, for example because it is on a removable drive or on a network drive that is not connected, the rule remains stored in a master database or list of rules and will be accessed when the document is next available and a user wishes to open it.

Viewed from another aspect, there is provided a method for carrying out a rule in response to a request to access a document which has been transmitted from a server and stored locally on client data processing apparatus; wherein the document is initially produced as a file of a type which is associated with a document viewing application; the method comprising the steps of modifying the file by including additional data concerning the rule and modifying the file type so as to be associated with a client application for managing and executing rules on the client data processing apparatus; transmitting the modified file to the client data processing apparatus and storing the modified file on the client data processing apparatus; noting a client request to access the document and invoking the client application in response to that request; using the client application to access the additional data and to carry out the rule; and, if permitted by the rule, using the client application to produce, from the modified file, a document file of a type compatible with the document viewing application; and opening the document file using the document viewing application.

The additional data may include a rule which is carried out by the client application, and/or data such as an expiry date which is used by a rule.

Viewed from another aspect of the invention there is provided a method for carrying out a rule in response to a request to access a document which is stored in a file on client data processing apparatus, the file being of a type associated with a client application for managing and executing rules; comprising the steps of transmitting to the client application additional data concerning the rule and using the client application to modify the file by the inclusion of the additional data; invoking the client application when a user seeks to access the document; carrying out the rule by accessing the additional data and, if permitted by the rule, using the client application to produce, from the file, a document file of a type compatible with a document viewing application; and opening the document file using the document viewing application.

In relation to these and other further aspects of the invention there are associated aspects corresponding to those indicated as a) to h) with respect to the first aspect discussed earlier.

Monitoring for updates to documents, or rule changes, on the document server could be carried out by a management server, such as the messaging server, which keeps its own copies of the documents and checks at regular intervals against the time/date stamp of the documents on the document server and if necessary downloads updated versions. Clients will then obtain their documents from the management/messaging server rather than directly from the document server. However, that has the problems discussed earlier. In the preferred embodiment of the invention, therefore, a document server application runs on the document server and automatically produces notification that an update has been made. An administrator or the author of a document on the document server can determine what actions need to be taken when a user seeks access to the document. The information is transmitted to the messaging server. The database is scanned for clients on which the original version of the document is stored locally, and messages containing the instructions can be prepared for those clients.

The document server application could enable the creation of instructions which allow certain documents to be held only for a certain time on a client machine before they expire. The user would be warned that the document has expired and needs to be refreshed.

The document server application preferably enables a library of instructions to be built so that the objects can be used many times.

When a client machine is connected to the Internet or whatever network the system is using, a connection is made to the messaging server and outstanding messages are retrieved. The messaging server could listen for all of the clients registered, and transmit messages when the presence of a client is detected. Preferably, the client application monitors access to the Internet and then connects to the messaging server. Bandwidth can be monitored and client messages only transmitted/retrieved when the user's Internet connection is quiet.

When the client application is connected to the messaging server for the first time, after installation, there may be a routine for registering the user as such rather than merely information identifying the location of the client machine. Information to be registered could include name, address, e-mail, telephone number, a user name and a password for example.

In certain situations a system in accordance with the invention can be used to enhance security. For example, when a document is downloaded to a user it may be given an id which is unique to that user/document combination. This could be the case for a tax return or other document on which the user will enter personal information. One way of ensuring security is to store a form and, separately, data which is used to complete the form. A particular user can access only the data specific to that user.

It is also possible to use a rule to provide secure access to a document. For example when a document such as a tax form is opened, there may be a rule specifying that access to stored data on a server must be accessed through a secure route rather than over the Internet. A rule may require that a user goes through a specific security system of, for example, a bank or insurance company.

Rules may deal with a wide range of situations. For example, one rule could be that when a document is accessed, other related documents must also be available. Another rule could be specific to PDA's (Personal Digital Assistants) or other devices with limited memory for storing documents, and could control how many documents may be stored on the device.

The client application is preferably of a type that can be easily re-written for any operating system. It is also preferably capable of being configured to work with various interfaces, such as HTML using a browser, a standard form type of interface, or even Flash™.

The expression “document” is to be construed broadly. It encompasses documents such as those produced in Microsoft Word™ (“.doc”) or Adobe Acrobat™ (“.pdf”, as well as spreadsheets, programs and other data that may be subject to updates. The system does not need to involve a change in the original document. For example, when a document is downloaded, instructions may be provided that it is only valid for a particular period (for example in accordance with a subscription). The client application would then carry out instructions which check whether the document is valid and advise a user if the document is no longer valid.

One system for carrying out various aspects of the invention comprises a data server, a messaging server and a client, wherein the client communicates over a network with the data server; a client copy of data is downloaded to the client from the data server and, by means of a data server application on the data server, information is transmitted to a client application on the client which identifies the data that has been downloaded; in accordance with the received information identifying the data, the client application communicates with the messaging server and registers information with a messaging server application on the messaging server, the information identifying the client and the data that has been downloaded; when the data that has been downloaded is updated on the data server, the data server application communicates with the messaging server and provides instructions to be carried out by the client application; by reference to the registered data, the instructions are provided to the client application by the messaging server application; the client application stores the instructions to be carried out; and the client application responds to a request by the user to access the client copy of the data, by carrying out the stored instructions.

It will be appreciated that references to servers and data processing apparatus do not imply single pieces of physical equipment. Client data processing apparatus may not be a single machine either and, for example, data could be stored in a server accessible to the client. The client could be a PC, a terminal communicating with a terminal server or a PC configured as a terminal.

Software can be provided on a physical carrier such as a disk or tape, or be provided from a remote location over a communications network.

An embodiment of the invention will now be described by way of example and with reference to the accompanying drawings in which:

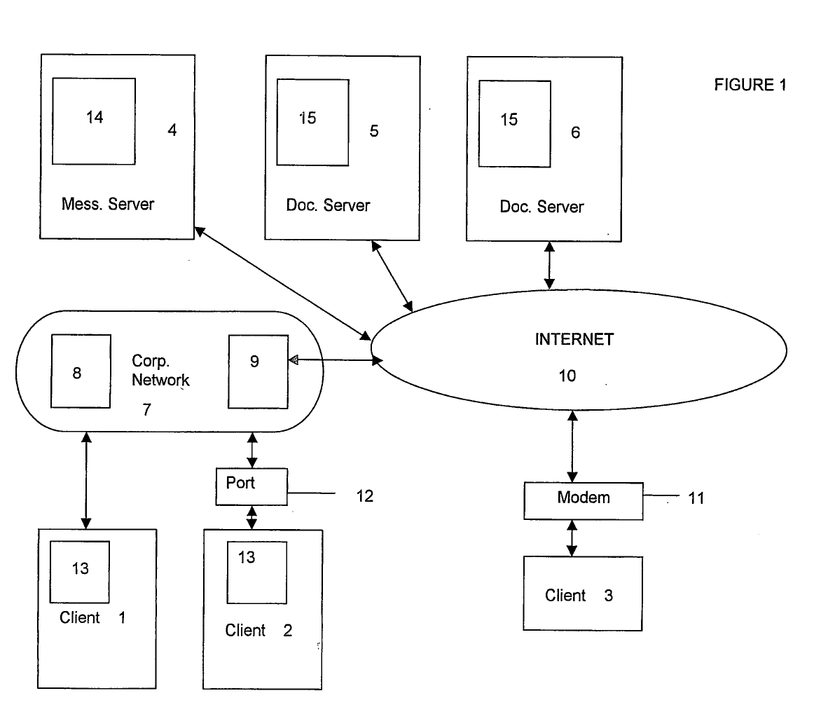

FIG. 1 is a diagram showing the general arrangement of hardware in a system in accordance with the invention;

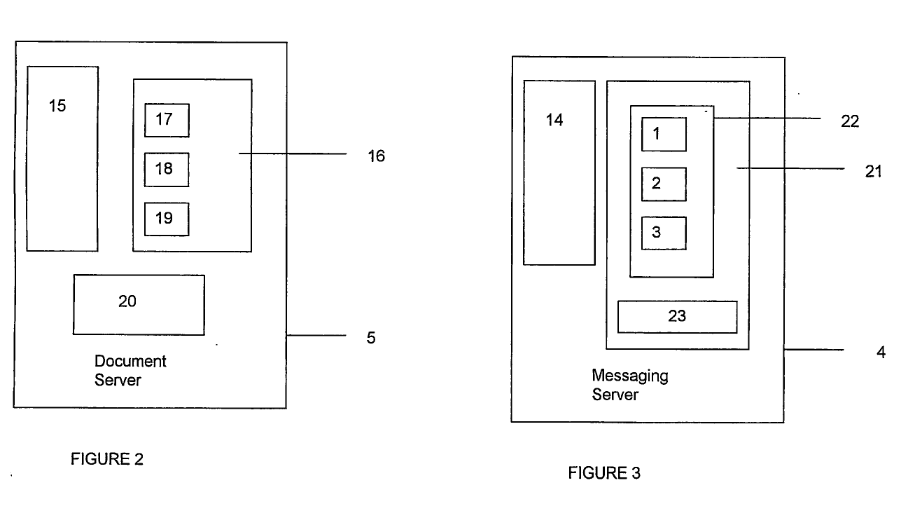

FIG. 2 is a diagram showing the arrangement of a document server in the system;

FIG. 3 is a diagram showing the arrangement of a management/messaging server in the system;

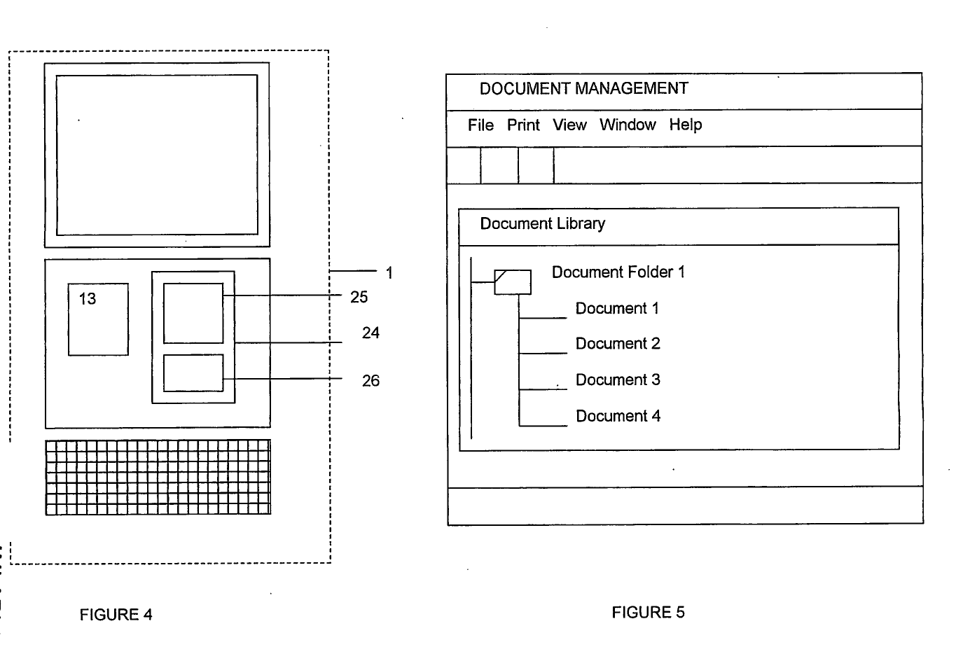

FIG. 4 is a diagram showing the arrangement of a client machine in the system;

FIG. 5 shows the user view of a library of documents on a client machine in the system; and

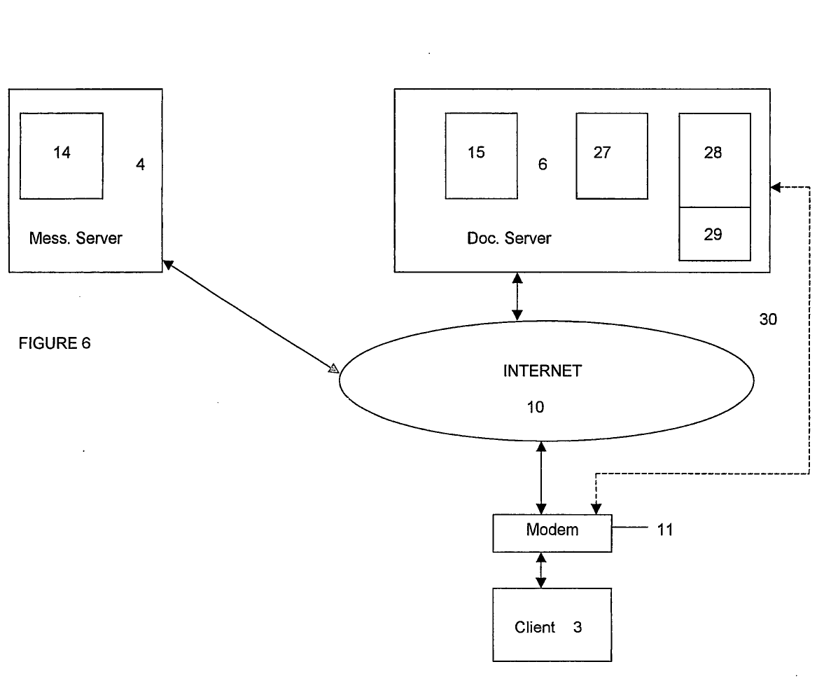

FIG. 6 shows a secure arrangement.

Referring now to FIG. 1, there are shown client machines 1, 2 and 3; a management/messaging server 4; and document servers 5 and 6. Client machine 1 is a desktop PC connected to a corporate network 7 including a network server 8 and a router 9 by means of which the PC 1 can connect to the Internet 10. Client machine 2 is a portable laptop computer which can connect to the corporate network 7 by means of a network port 12, and can then connect to the Internet. Typically, client machine 2 would be used by a independent financial adviser who would take it to visit customers, giving quotations and documents from off line versions of documents stored locally on the laptop PC. Client machine 3 is a desktop PC which can connect to the Internet by means of a dial up connection using a modem 11. A client application 13 in the form of an intelligent agent has already been installed on client machines 1 and 2. A management/messaging server application 14 has been installed on server 4, and a document server application 15 on each of servers 5 and 6.

As shown in FIG. 2, on the document server 5 there is a library 16 of documents such as 17, 18 and 19. Typically, document server 5 is run by a life insurance company and documents 17, 18 and 19 are various insurance policies. There is also a library 20 of XML objects containing instructions to be carried out when a document is to be updated. The document server application 15 has embedded in or associated with each document a unique identifier, a version control identifier and an identifier indicating that the document is for use in the system in accordance with the invention. When to document server receives a document request from client 1, 2 or 3, it first interrogates the client to determine whether the client application has been installed. In the case of client machines 1 and 2, the client application has been installed and thus downloading of a document to either client machine will commence once a request is received.

In the case of a request for a document from client machine 3, the document server application detects that the client application has not been installed. In that event, an XML object transmitted by the documents server application to the client machine 3 asks the user whether it is desired to download the client application. If the user agrees, the client application is downloaded either from the document server or from the messaging server, and installed. Once that has happened, downloading of the requested document is completed. With the client application installed, the client machine 3 registers itself with the messaging server 4. The minimum information will be a unique identifier for the machine, but there may also be a registration form for further information to be provided. The client application then registers with the messaging server the unique document identifier and version identifier of the downloaded document, and the source of the document, as being present on that machine. Further registration information can be stored on the messaging server, or can be transmitted to the document server by the messaging server, or can be transmitted directly from the client machine to the document server, depending on what business rules have been set up. Each time a new document is requested from client machine 3, the document server application detects the presence of the client application and the document is downloaded without an initial registration routine.

The document in a preferred arrangement is in the form of a file which has an original part in the form of document data compatible with a document display application such as Microsoft Word or Adobe Acrobat, whether full versions for also creating and editing documents or versions for viewing documents only. To this is added a header in the form of rule data and the file type is altered to a form compatible with the client application 13. When a user seeks to open the document, the client application will carry out rules in accordance with the rule data and, if the rules permit, provide a file which is opened by the document display application, to display the document.

FIG. 3 shows the messaging/management server 4 in more detail. Following the registration of client machine 3, there is a database 21 which holds registration data 22 for the three client machines 1, 2 and 3, and document data 23. Each record in the document data contains the identifier for a client machine, the id of a document downloaded to that machine, the source of the document, and the version identifier for the document. The database also holds update data, and each record includes the document identifier, the source, the version identifier and an XML object containing instructions to be carried out when a user on a client machine seeks to access the document. This update data has been transmitted to the messaging server by the document server application, as documents on the document server are updated.

FIG. 4 shows client machine 1 in more detail. On the client machine 1, the client application 13 has been installed and has established a database 24 which includes document data 25 identifying documents which have been downloaded, each record including the source, the document identifier and the version identifier. Each time a new document or version is downloaded, the database is updated and the client application automatically communicates with the messaging server 4 to register the new document/version. The client application detects when the client machine is connected to the Internet. At each new connection session, and at predetermined intervals during a session, the client application connects to the messaging server and informs the messaging server application that it is available to receive communications. The messaging server application looks for documents which are registered for the client machine and then checks for update data in respect of those documents. If update data is located, a message is created sending the update instructions (in the form of an XML object) to the client application. The update instructions are then stored as update data 26 in the database 24.

FIG. 5 shows diagrammatically a document library view of documents in the database 24. The documents are listed for a client to select for viewing. When a user clicks on a particular document to open it the client application looks for any update data stored in the database for that document. If instructions are located, then they are carried out. Typically the instructions will delete the existing version of the document advise the user that the document has been removed as it is out of date, ask the user to confirm that the latest version is to be downloaded, and then connect the client machine to the document server so that the updated version is downloaded. The database in the client application is updated and the client application will register the existence of the updated document with the messaging server.

The client application may run in the background only, with there being no specific display of the application to the user and documents being opened and rules being run without the need to access a document library.

The client application is preferably a small application, typically of about 500 k, that can run in an environment such as Windows, and it may for example sit on the tool bar or be invisible to the end user except when the document library is to be viewed. The application may run as Windows Service Mode, which can for example be hosted by Windows NT Servicing to provide a simple yet stable environment for the application to run in. However client applications can be provided for Linux, Unix and Apple users or any other operating systems.

FIG. 6 shows a secure arrangement using document server 6. There is a standard document 27, which could for example be a tax return form to be filled in by users. There is also a database 28 of specific instances of the standard document 27, each containing information specific to a particular user. When a user downloads the standard document 27, the client application acts in accordance with instructions in an XML object associated with the document, to prompt for user registration such as name, address, a tax number and so forth. The client application is instructed to create a unique identifier to identify a specific instance 29 of the document which will contain the details for the particular user. This specific instance is stored in the database 28. The user can work off line on client machine 3, for example, creating the specific instance 29 by filling in the blank tax return form. When the client wishes to submit the tax return the specific instance 29 is transmitted to database 28 from the client application. When the user wishes to review or edit the tax return form, this is carried out on the specific instance 29 on the client machine. Once any changes have been made, the client application transmits the updated version to the database 28 on the document server. If any update are made at the document server end, these can be handled by XML instructions in the manner described earlier so that the client copy will be updated.

Thus, whilst there is free access to blank forms, a specific instance of a form with data on the document server 6 cannot be accessed as such. The user accesses an identical copy on the local machine, and then update information is pushed to the specific instance on the server under control of the client application. Thus, a user cannot access the specific instances on the server and there is no risk of a user opening another person's form. In some embodiments, the specific instance stored on the document server database 28 is data which is combined with a blank form when the details are to be viewed, rather than a completed form as such.

The document 27 is associated with a rule that dictates the route 30 that the client machine uses to communicate with the document server 6 to transmit the data about the specific instance 29. This bypasses the conventional Internet route for increased security. Whilst the blank form 27 and the rules may be transmitted from messaging server 4 to the client machine 3 via a conventional internet route 10, the data passes via the more secure route 30.

There are two types of XML components that may be used in a system in accordance with the invention. An XML Object is used to send or receive data depending on a user event such as clicking on a button, or a timer event. The XML object is then invoked so that information is sent to a server, and a posted reply from the server is awaited. An XML Socket Object is an object that is used to send data the other way. A server connects to all listening clients and broadcasts information to them. The listening client application will then e.g. display information on a screen, depending on the data that has been sent. Updates could be sent to locally stored data, provided a client is on line.

To establish a secure connection, conventional SSL technology could be used. In a one possible arrangement, however, when a document is requested from a server and is downloaded to a client machine, an XML object generated by the document server application instructs the client application as to the route via which the document is to be transferred. Thus the normal Internet can be cut out for the transfer, although a user may go first to an Internet Service Provider which recognises a request for a specified route and is set up to provide access to that route. The XML object will direct the flow and instruct the publishing server to transfer the document to the client.

There are many different aspects of the invention, including those identified above, those claimed and those that are apparent to the skilled reader of the specification. Additional aspects include but are not limited to the following.

A method of operating data processing apparatus, in which client data processing apparatus communicates over a network with a document server on which is stored an original copy of a document, a client copy of the document is received by the client data processing apparatus for off line use, a server on the network registers data indicating that the client copy of the document is on the client data processing apparatus, and in which, following an update to the document on the document server, and by reference to the registered data, information relating to the updated document is provided to the client data processing apparatus; wherein, following an update to the document on the document server, a message is communicated to a client application on the client data processing apparatus indicating that the document has been updated; in accordance with the message the client application stores instructions to be carried out when a user next seeks to access the client copy of the document; the client application detects a request by the user to access the client copy of the document; and in response to such a request being made, the client application carries out the stored instructions so that the client copy of the document can be updated.

Data processing apparatus configured as client data processing apparatus in a system in which the client data processing apparatus communicates over a network with a document server on which is stored an original copy of a document, and a client copy of the document is received by the client data processing apparatus for off line use; in which a client application on the client data processing apparatus registers data with a server on the network indicating that the client copy of the document is on the client data processing apparatus; the client application receives a message from the server on the network containing update information relating to the document; in accordance with the message the client application stores instructions to be carried out when a user next seeks to access the client copy of the document; the client application detects a request by the user to access the client copy of the document; and in response to such a request being made, the client application carries out the stored instructions so that the client copy of the document can be updated.

A method of operating data processing apparatus configured as client data processing apparatus in a system in which the client data processing apparatus communicates over a network with a document server on which is stored an original copy of a document, and a client copy of the document is received by the client data processing apparatus for off line use; in which a client application on the client data processing apparatus registers data with a server on the network indicating that the client copy of the document is on the client data processing apparatus; the client application receives a message from the server on the network containing update information relating to the document; in accordance with the message the client application stores instructions to be carried out when a user next seeks to access the client copy of the document; the client application detects a request by the user to access the client copy of the document; and in response to such a request being made, the client application carries out the stored instructions so that the client copy of the document can be updated.

Software which when running on data processing apparatus will cause the data processing apparatus to be configured as client data processing apparatus in a system in which the client data processing apparatus communicates over a network with a document server on which is stored an original copy of a document, and a client copy of the document is received by the client data processing apparatus for off line use; in which a client application on the client data processing apparatus registers data with a server on the network indicating that the client copy of the document is on the client data processing apparatus; the client application receives a message from the server on the network containing update information relating to the document; in accordance with the message the client application stores instructions to be carried out when a user next seeks to access the client copy of the document; the client application detects a request by the user to access the client copy of the document; and in response to such a request being made, the client application carries out the stored instructions so that the client copy of the document can be updated.

Data processing apparatus configured as a messaging server in a system in which the messaging server receives data indicating that a client copy of an original document on a document server has been downloaded to client data processing apparatus and registers data identifying the document and the client data processing apparatus; in which, following an update to the document on the document server, the messaging server receives and stores data from the document server identifying the document and containing instructions to be carried out by a client application on the client data processing apparatus; the messaging server is placed in communication with the client data processing server; and by reference to the registered data, information relating to the updated document is provided by the messaging server to the client data processing apparatus, such information including instructions to be carried out automatically on the client data processing apparatus when a user next seeks to access the document on the client data processing apparatus.

A method of operating data processing apparatus configured as a messaging server in a system in which the messaging server receives data indicating that a client copy of an original document on a document server has been downloaded to client data processing apparatus and registers data identifying the document and the client data processing apparatus; in which, following an update to the document on the document server, the messaging server receives and stores data from the document server identifying the document and containing instructions to be carried out by a client application on the client data processing apparatus; the messaging server is placed in communication with the client data processing server; and by reference to the registered data, information relating to the updated document is provided by the messaging server to the client data processing apparatus, such information including instructions to be carried out by the client application on the client data processing apparatus when a user next seeks to access the document on the client data processing apparatus.

Software which when running on data processing apparatus will cause the data processing apparatus to be configured as a messaging server in a system in which the messaging server receives data indicating that a client copy of an original document on a document server has been downloaded to client data processing apparatus and registers data identifying the document and the client data processing apparatus; in which, following an update to the document on the document server, the messaging server receives and stores data from the document server identifying the document and containing instructions to be carried out by a client application on the client data processing apparatus; the messaging server is placed in communication with the client data processing server; and by reference to the registered data, information relating to the updated document is provided by the messaging server to the client data processing apparatus, such information including instructions to be carried out automatically on the client data processing apparatus when a user next seeks to access the document on the client data processing apparatus.

Data processing apparatus configured as a document server in a system in which client data processing apparatus communicates over a network with the document server on which is stored an original copy of a document, a client copy of the document is supplied by the document server to the client data processing apparatus for off line use, a messaging server on the network registers data indicating that the client copy of the document is on the client data processing apparatus, and in which, following an update to the document on the document server, data is transmitted by a document server application to the messaging server relating to the update and containing instructions to be carried out by the client data processing apparatus in response to the update; and by reference to the registered data, information relating to the updated document, including the instructions, is provided by the messaging server to a client application on the client data processing apparatus and the client application stores the instructions so as to be carried out when a user next seeks to access the client copy of the document; the document server receives a request, in accordance with the stored instructions, for the updated document to be downloaded to the client data processing apparatus; and the document server downloads the updated document to the client data processing apparatus.

A method of operating data processing apparatus configured as a document server in a system in which client data processing apparatus communicates over a network with the document server on which is stored an original copy of a document, a client copy of the document is supplied by the document server to the client data processing apparatus for off line use, a messaging server on the network registers data indicating that the client copy of the document is on the client data processing apparatus, and in which, following an update to the document on the document server, data is transmitted by a document server application to the messaging server relating to the update and containing instructions to be carried out by the client data processing apparatus in response to the update; and by reference to the registered data, information relating to the updated document, including the instructions, is provided by the messaging server to a client application on the client data processing apparatus and the client application stores the instructions so as to be carried out when a user next seeks to access the client copy of the document; the document server receives a request, in accordance with the stored instructions, for the updated document to be downloaded to the client data processing apparatus; and the document server downloads the updated document to the client data processing apparatus.

Software which when running on data processing apparatus will cause the data processing apparatus to be configured as a document server in a system in which client data processing apparatus communicates over a network with the document server on which is stored an original copy of a document, a client copy of the document is supplied by the document server to the client data processing apparatus for off line use, a messaging server on the network registers data indicating that the client copy of the document is on the client data processing apparatus, and in which, following an update to the document on the document server, data is transmitted by a document server application to the messaging server relating to the update and containing instructions to be carried out by the client data processing apparatus in response to the update; and by reference to the registered data, information relating to the updated document, including the instructions, is provided by the messaging server to a client application on the client data processing apparatus and the client application stores the instructions so as to be carried out when a user next seeks to access the client copy of the document; the document server receives a request, in accordance with the stored instructions, for the updated document to be downloaded to the client data processing apparatus; and the document server downloads the updated document to the client data processing apparatus.

The various aspects of the invention are of particular but by no means exclusive use in the context of ensuring that documents stored locally are kept up to date. They are also or alternatively applicable to managing security issues, monitoring the expiry date of a document or of a subscription permitting access to the document, and carrying out other rules which can be triggered when a user seeks to open a document.

In a typical implementation of the invention, many different users will be registered, with different lists of documents that they have downloaded. There may be different lists of documents between users.

1. A method in which client data processing apparatus communicates over a network with a document server on which is stored an original copy of a document, a client copy of the document is received by the client data processing apparatus for off line use, and a server on the network registers data indicating that the client copy of the document is on the client data processing apparatus;
wherein a rule is generated relating to the document;
by reference to the registered data in respect of the client data processing apparatus the rule is communicated to a client application on the client data processing apparatus;
in accordance with the rule the client application stores an instruction to be carried out when a user next seeks to access the client copy of the document;
a request is made by the user to access the client copy of the document; and
in response to such a request being made, the client application carries out the stored instruction.

2. A method as claimed in claim 1, wherein the rule concerns an updated version of the document which must be downloaded to replace the client copy of the document.

3. A method as claimed in claim 1, wherein the rule concerns the security of communication between the client data processing apparatus and the document server.

4. A method as claimed in claim 3, wherein the rule specifies a secure route of communication between the client data processing apparatus and the document server.

5. A method as claimed in claim 1, wherein the client copy of the document is in the form of a file comprising the document and rule data, the file being of a type associated with the client application, and wherein the client application accesses the file, carries out at least one rule using the rule data and, if the rule permits, opens the document part of the file in a document viewing application.

6. A method as claimed in claim 5, wherein the client application may modify the rule data contained in the file stored on the client data processing apparatus, in response to the receipt of a rule update instruction.

7. A method as claimed in claim 1, wherein the client application maintains a list of documents stored on the client data processing apparatus and associated current rules.

8. A data processing system comprising a document server, a messaging server and a client, wherein the client communicates over a network with the document server to request a copy of a document stored on the document server;
the document server is configured so that in response to such request a client copy of the document is downloaded to the client from the data server;
the client is configured so that a client application running on the client communicates with the messaging server and registers information with a messaging server application, the information identifying the client and the document that has been downloaded;
the document server is further configured so that when the document that has been downloaded is updated on the document server, the document server application communicates with the messaging server and provides instructions to be carried out by the client application;
the messaging server is configured so that by reference to the registered data, the instructions are provided to the client application by the messaging server application; and
the client is further configured so that client application stores the instructions to be carried out and that in response to a request by a user to access the client copy of the document the stored instructions are carried out.

9. Data processing apparatus configured as client data processing apparatus in a system in which the client data processing apparatus communicates over a network with a document server on which is stored an original copy of a document, and a client copy of the document is received by the client data processing apparatus for off line use;
in which a client application on the client data processing apparatus registers data with a server on the network indicating that the client copy of the document is on the client data processing apparatus;
the client application receives a message from the server on the network containing update information relating to the document;
in accordance with the message the client application stores instructions to be carried out when a user next seeks to access the client copy of the document; and
in response to a request by the user to access the client copy of the document the client application carries out the stored instructions so that the client copy of the document can be updated.

10. A computer program product comprising a computer useable medium having a computer readable code means embodied in said medium for causing the computer to be configured as client data processing apparatus in accordance with claim 9.

11. Data processing apparatus configured as a messaging server in a system in which the messaging server receives data indicating that a client copy of an original document on a document server has been downloaded to client data processing apparatus and registers data identifying the document and the client data processing apparatus;
in which, following an update to the document on the document server, the messaging server receives and stores data from the document server identifying the document and containing instructions to be carried out by a client application on the client data processing apparatus;
the messaging server is placed in communication with the client data processing server; and
by reference to the registered data, information relating to the updated document is provided by the messaging server to the client data processing apparatus, such information including instructions to be carried out automatically by the client application on the client data processing apparatus when a user next seeks to access the document on the client data processing apparatus.

12. A computer program product comprising a computer useable medium having a computer readable code means embodied in said medium for causing the computer to be configured as a messaging server in accordance with

13. Data processing apparatus configured as a document server in a system in which client data processing apparatus communicates over a network with the document server on which is stored an original copy of a document, a client copy of the document is supplied by the document server to the client data processing apparatus for off line use, a messaging server on the network registers data indicating that the client copy of the document is on the client data processing apparatus, and in which, following an update to the document on the document server, data is transmitted by a document server application to the messaging server relating to the update and containing instructions to be carried out by the client data processing apparatus in response to the update;
and by reference to the registered data, information relating to the updated document, including the instructions, is provided by the messaging server to a client application on the client data processing apparatus and the client application stores the instructions so as to be carried out when a user next seeks to access the client copy of the document;
the document server receives a request, in accordance with the stored instructions, for the updated document to be downloaded to the client data processing apparatus; and
the document server downloads the updated document to the client data processing apparatus.

14. A computer program product comprising a computer useable medium having a computer readable code means embodied in said medium for causing the computer to be configured as a document server in accordance with claim 13.

15. A method for carrying out a rule in response to a request to access a document which has been transmitted from a server and stored locally on client data processing apparatus;
wherein the document is initially produced as a file of a type which is associated with a document viewing application;
the method comprising the steps of modifying the file by including additional data concerning the rule and modifying the file type so as to be associated with a client application for managing and executing rules on the client data processing apparatus;
transmitting the modified file to the client data processing apparatus and storing the modified file on the client data processing apparatus;
noting a client request to access the document and invoking the client application in response to that request;
using the client application to access the additional data and to carry out the rule;
and, if permitted by the rule, using the client application to produce, from the modified file, a document file of a type associated with the document viewing application; and
opening the document file using the document viewing application.

16. A method for carrying out a rule in response to a request to access a document which is stored in a file on client data processing apparatus, the file being of a type associated with a client application for managing and executing rules;
comprising the steps of transmitting to the client application additional data concerning the rule and using the client application to modify the file by the inclusion of the additional data;
invoking the client application when a user seeks to access the document;
carrying out the rule by accessing the additional data and, if permitted by the rule, using the client application to produce, from the file, a document file of a type associated with a document viewing application; and opening the document file using the document viewing application.

17. A data processing system comprising a data server, a messaging server and a client, wherein the client communicates over a network with the data server;
the system being configured so that a client copy of data is downloaded to the client from the data server;
the client application communicates with the messaging server and registers information with a messaging server application on the messaging server, the information identifying the client and the data that has been downloaded;
when the data that has been downloaded is updated on the data server, the data server application communicates with the messaging server and provides instructions to be carried out by the client application;
by reference to the registered information, the instructions are provided to the client application by the messaging server application;
the client application stores the instructions to be carried out; and
in response to a request by the user to access the client copy of the data, the client application carries out the stored instructions.
